(19) United States
(12) Patent Application Publication
(10) Pub. No.: US 2025/0192657 A1
(43) Pub. Date: Jun. 12, 2025

(54) REFRESHING BOOTSTRAP CAPACITORS ASSOCIATED WITH SWITCHES OF POWER STAGES IN SWITCHING CONVERTERS

(71) Applicant: Shaoxing Yuanfang Semiconductor Co., Ltd., Shaoxing (CN)

(72) Inventors: Arnold J D'Souza, Bangalore (IN); Shyam Somayajula, Bangalore (IN); Yunsong Wang, Shanghai (CN); Yiren Wang, Shanghai (CN)

(21) Appl. No.: 18/922,467

(22) Filed: Oct. 22, 2024

(30) Foreign Application Priority Data
Dec. 12, 2023 (IN) 202341084703

(51) Int. Cl. H02M 1/00; H02M 1/08; H02M 1/32; H02M 3/07; H02M 3/158

(52) U.S. Cl. CPC H02M 1/0006; H02M 1/08; H02M 1/32; H02M 3/07; H02M 3/1586

(57) ABSTRACT

A power stage of a voltage regulator includes a high-side switch, a low-side switch, a gate-driver, a power management block, a bootstrap capacitor and a refresh block. The power management block is designed to receive a power-control signal, and to cause both of the high-side switch and low-side switch to be switched OFF when said power-control signal is in a first state. The bootstrap capacitor is provided to enable said high-side switch to be switched ON. The cross-terminal voltage across the bootstrap capacitor is required to be above a first threshold voltage for reliable operation of the high-side switch. The refresh block is designed to refresh the bootstrap capacitor to maintain the cross-terminal voltage above the first threshold voltage while both the high-side switch and low-side switch continue to be in the OFF state when the power-control signal is in the first state.

### PRIORITY CLAIM

The instant patent application is related to and claims priority from the co-pending provisional India patent application entitled, “REFRESH ENABLE ON SYNC HI-Z”, Serial No. 202341084703, Filed: 12 Dec. 2023; Attorney docket no.: AURA-354-INPR, which is incorporated in its entirety herewith to the extent not inconsistent with the description herein.

### BACKGROUND

### Technical Field

Embodiments of the present disclosure relate generally to power supply circuits, and particularly to refreshing bootstrap capacitors in switching converters.

### Related Art

A switching converter refers to a component which generates a regulated DC (direct current) voltage from an input power source by employing one or more switches, as is well known in the relevant arts. Switching converters are used in devices such as computers and mobile phones, as is also well known in the relevant arts.

A power stage is an integral block of a switching converter, and often contains a pair of transistors referred to as a high-side switch and a low-side switch coupled in series, as is also well known in the relevant arts. The switches are turned on/off (referred to as ‘switching’) in alternate durations to cause the power stage to generate the desired regulated DC voltage.

A bootstrap capacitor may be employed to provide a voltage level needed for switching on/off a switch of a power stage. For example, when the high-side switch is realized as an NMOS transistor (N-channel MOSFET, i.e., N-channel Metal Oxide Semiconductor Field Effect Transistor), a bootstrap capacitor is often employed to assist in generating the voltages needed for switching ON the high-side switch.

There are often scenarios when a bootstrap capacitor may not have sufficient voltage for the desired switching operation, and may require refreshing (i.e., process of recovering to a desired voltage) of the voltage of the bootstrap capacitor. Aspects of the present disclosure are directed to such refreshing of the bootstrap capacitor.

### BRIEF DESCRIPTION OF THE VIEWS OF DRAWINGS

Example embodiments of the present disclosure will be described with reference to the accompanying drawings briefly described below.

FIG. 1 is a block diagram of an example system in which several aspects of the present disclosure can be implemented.

FIG. 2 is a block diagram illustrating the details of a voltage regulation module (VRM) in an embodiment of the present disclosure.

FIG. 3 is a block diagram illustrating the implementation details of a power stage in an embodiment of the present disclosure.

FIG. 4 is a diagram illustrating the details of a detection block and a refresh block of a power stage in an embodiment of the present disclosure.

FIG. 5 is a timing diagram illustrating refresh operations of a bootstrap capacitor of a power stage in response to a signal to shut-down the power stage, in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

A power stage of a voltage regulator includes a high-side switch, a low-side switch, a gate-driver, a power management block, a bootstrap capacitor and a refresh block. The power management block is designed to receive a power-control signal, and to cause both of the high-side switch and low-side switch to be switched OFF when said power-control signal is in a first state. The bootstrap capacitor is provided to enable said high-side switch to be switched ON. The cross-terminal voltage across the bootstrap capacitor is required to be above a first threshold voltage for reliable operation of the high-side switch.

According to an aspect of the present disclosure, the refresh block is designed to refresh the bootstrap capacitor to maintain the cross-terminal voltage above the first threshold voltage while both the high-side switch and low-side switch continue to be in the OFF state when the power-control signal is in the first state.

In an embodiment, the refresh block refreshes the bootstrap capacitor only if the voltage at the junction of the high-side switch and the low-side switch is greater than a second threshold when the power-control signal is in the first state.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example System

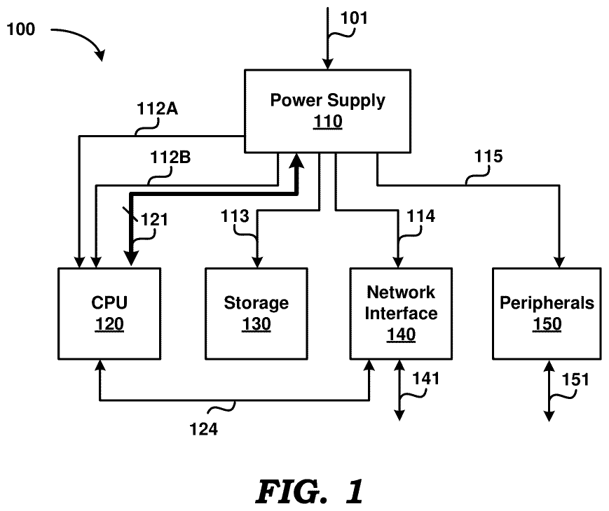

FIG. 1 is a block diagram of an example system in which several aspects of the present disclosure can be implemented. System 100 is shown containing power supply 110, central processing unit (CPU) 120, storage 130, network interface 140 and peripherals 150. In an embodiment, system 100 corresponds to a computer (desktop, laptop, etc.), although system 100 can represent other types of systems in other embodiments. It is understood that system 100 can contain more or fewer blocks than those shown in FIG. 1.

CPU 120, in general, represents a processor or a system-on-chip (SoC), and is shown as receiving a pair of supply voltages (Va and Vb) on respective paths 112A and 112B from power supply 110. As an example, Va may be a smaller voltage than Vb, and may be used to power a core portion of CPU which may include arithmetic logic unit (ALU), microprogram sequencer, registers, etc. Vb may be used to power the rest of CPU 120, such as for example, input/output (I/O) units, I/O buffers, on-chip peripherals etc. CPU 120 provides various signals (all deemed to be contained in bidirectional path/bus 121) specifying, among others, its power supply requirements to power supply 110. Examples of such signals can be those that specify the specific mode of operation (in terms of power consumption) such as PS1, PS2, PS3, etc., which refer to “Power Save States for Improved Efficiency”. CPU 120 receives health information of the power stages from phase controller 210 via bidirectional path/bus 121.

Storage 130 represents a memory that may include both volatile and non-volatile memories. For example, in a personal computer, storage can include magnetic memory (hard disk) as well as solid state memory (RAM, Flash, etc.). Storage 130 is shown receiving a supply voltage on path 113 for powering various circuits and blocks within.

Network interface 140 operates to provided two-way communication between system 100 and a computer network, or in general the Internet. Network interface 140 implements the electronic circuitry required to communicate using a specific physical layer and data link layer standard such as Ethernet or Wi-Fi™. Network interface 140 may also contain a network protocol stack to allow communication with other computers on a same local area network (LAN) and large-scale network communications through routable protocols, such as Internet Protocol (IP). Network interface 140 receives a power supply on path 114 for powering internal circuits and blocks. Network interface 140 receives from/transmits to external systems and CPU 120 respectively on path 141 and path 124.

Peripherals 150 represents one or more peripheral circuits, such as for example, speakers, microphones, user interface devices, etc. Peripherals 150 receives a power supply on path 115, and communicates with external devices on path 151.

Power supply 110 receives power from one or more sources (e.g., batteries, which in turn may be connected to be charged from mains supply via rectifiers and filters) on path 101, and operates to provide the desired power supply voltages on paths 112A, 112B, 113, 114 and 115. In an embodiment, power supply 110 is designed to contain one or more multi-phase DC-DC converters within to generate the power supply voltages. Power supply 110 receives signals from CPU 120 received on path 121 that may indicate power-modes in which CPU 120 is to operate in a particular duration, with the power-modes representing a magnitude of power that CPU 120 is likely to require/consume from power supply 110. Power supply 110 responds to the signals by controlling the multi-phase converter(s) to reduce/increase current output based on the specific power-mode signal (e.g., PS1, PS2 and PS3).

In an embodiment, power supply 110 is a voltage regulator module (VRM), sometimes also called processor power module (PPM), and contains one or more step-down switching (buck) converters to generate one or more smaller voltages from a higher-voltage supply source. In other embodiments however, other types of DC-DC converters such as boost, buck-boost, hysteretic converters etc., can be implemented instead of a buck converter. Further, power supply 110 can be implemented as a standalone switching converter with only one power stage (and therefore not be a multi-phase converter). With a VRM, multiple devices/ICs requiring different supply voltages can be mounted on the same platform, for example, a computer motherboard of a personal computer (PC).

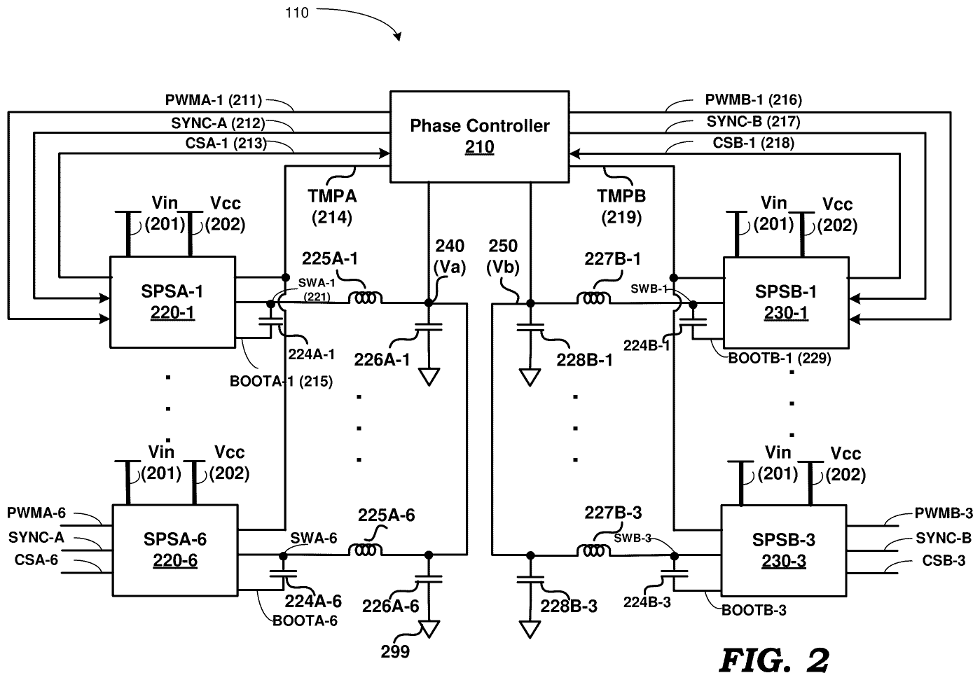

The description is continued with respect to the internal details of a VRM as shown in FIG. 2.

### 3. Voltage Regulator Module (VRM)

FIG. 2 is a block diagram illustrating the details of a VRM in an embodiment of the present disclosure. Power supply 110 is shown implemented as a multi-phase Voltage Regulator Module generating two regulated supply voltages Va and Vb using a phase controller and two sets of power stages, one set for each supply rail (regulated voltage Va or Vb). Thus, VRM 110 is shown containing phase controller 210, smart power stages (SPS, or simply ‘power stages’) SPSA-1 (220-1) through SPSA-6 (220-6), SPSB-1 (230-1) through SPSB-3 (230-3), inductors 225A-1 through 225A-6, 227B-1 through 227B-3, output capacitors 226A-1 through 226A-6, 228B-1 through 228B-3, and bootstrap capacitors 224A-1 through 224A-6, 224B-1 through 224B-3. Each bootstrap capacitor associated with an SPS is shown connected between nodes SW (switching node) and BOOT of the corresponding SPS.

Thus, bootstrap capacitor 224A-1 is shown connected between switching node SWA-1 (221) and BOOTA-1 (215). Although bootstrap capacitor is shown connected external to each SPS, typically, or in alternative embodiments, bootstrap capacitor may be internal to the SPS. The voltage at node SWA-1 (221) is conveniently referred to herein as Vsw. Although, the description below is provided in the context of a multi-phase switching converter, with separate power stages and phase controller (all typically implemented in integrated circuit (IC) form), the features of the present disclosure are applicable in a stand-alone (single-phase) switching converter also, as will be clear to one skilled in the relevant arts by reading the disclosure herein.

Power supply Va (240) is generated by a 6-phase buck switching converter (there are six SPSes-220-1 through 220-6), while power supply Vb (250) is generated by a 3-phase buck switching converter (there are three SPSes-230-1 through 230-3). Nodes/Paths 240 and 250 correspond to paths 112A and 112B respectively of FIG. 1. In the interest of conciseness, other power supply circuits that generate supplies on paths 113, 114 and 115 are not shown in FIG. 2.

The combination of (corresponding circuitry within) phase controller 210, an SPS, an inductor and a capacitor forms one “phase” of each of the two multi-phase buck converters. Thus, for example, SPSA-1, inductor 225A-1, capacitor 226A-1, and the corresponding portion within phase controller 210 represent one phase of the 6-phase buck converter. It is noted here that, while each phase is shown as having its own separate capacitor (e.g., 226A-1), in another embodiment, only a single larger capacitor (larger capacitance) may be employed at node 240 (as well as 250). In other embodiments, multiple capacitors are placed close to the load powered by the corresponding supply voltage.

Each SPS may be implemented to contain a high-side switch, a low-side switch, gate-drive circuitry for the two switches, and other circuits. In some embodiments, if operation in only discontinuous current mode (DCM) is required, then a diode may be used in place of the low-side switch. Examples of other circuits include, but are not limited to, temperature monitor circuit, inductor-current sense (or emulation) circuit, etc., to provide information, such as temperature of the SPS, magnitude of inductor-current, etc., to phase controller 210. Each SPS receives a source of power as an input which is connected to the high-side switch (shown in detail in sections below). In FIG. 2, the supply source is numbered 201, and has a voltage Vin. An example value of Vin in a VRM is about 21 volts (V). Each SPS is also shown as receiving a voltage Vcc on path 202, and may be provided by phase controller 210. Example value of Vcc in a VRM is about 3.3 V.

Each SPS communicates with phase controller 210 via corresponding signals PWM, SYNC, CS and TMP. Thus, SPSA-1 is shown connected to phase controller 210 through signal/paths PWMA-1 (211), SYNC-A (212), CSA-1 (213) and TMPA (214). SPSA-6 communicates with phase controller 210 via signals PWMA-6, SYNC-A, CSA-6 and TMPA (214). Similarly, SPSB-1 is shown connected to phase controller 210 through signal/paths PWMB-1 (216), SYNC-B (217), CSB-1 (218) and TMPB (219). SPSB-3 communicates with phase controller 210 via signals PWMB-3, SYNC-B, CSB-3 and TMPB (219). The other SPSes would have similar connections with phase controller 210.

Signal PWM is an input to an SPS and is a pulse-width modulated (PWM) signal, which may, for example, be a signal of a fixed frequency but variable duty-cycle, and whose frequency is potentially modifiable by phase controller 210 based on load-current demands. Alternatively, signal PWM may be of other types, such as, for example, a variable frequency, constant-ON time signal.

The PWM signal controls the opening and closing of high-side switch and low-side switch of the SPS. When PWM is a fixed frequency, variable duty cycle signal, the duty cycle of the PWM signal is set by phase controller 210 and is designed to generate the desired power supply voltage and/or control/change the current supplied by that phase. For example, PWMA-1 would have a duty cycle as required for the magnitude of Va and the current to be provided by SPSA-1. As is well known in the relevant arts, the PWM signals to each SPS of a same converter are typically staggered, i.e., delayed with respect to each other in phase such that typically the ON duration of no two (or more) high-side switches or low-side switches in the converter (i.e., respective SPSes) overlaps. Such a technique is employed for reasons such as, for example, to ensure that the peak instantaneous current drawing from Vin is relatively low (or zero) at all times.

In an embodiment, signal PWM represents a three-state input from phase controller 210. When logic LOW is detected by the SPS on signal PWM, the low-side switch is turned ON, and when logic HIGH is detected on signal PWM, the high-side switch is turned ON. A high-impedance (hi-Z) value (typically a voltage mid-way between the logic high and logic low voltage levels) on signal PWM is designed to turn OFF both the high-side and the low-side switches of the corresponding SPS.

Signal TMP is an output from an SPS to phase controller 210, and provides information regarding the temperature in the SPS. Phase controller 210 may process the TMP signal (or the information contained in it) to adjust the current supplied by that phase, or for shut-down of the VRM. The TMP outputs of each phase of a converter are wired together, and a single input is connected to phase controller 210.

Signal SYNC is a power-control signal and is an input to an SPS. Signal SYNC may be used by phase controller 210 to indicate whether the SPS is to generate regulated voltage Va or Vb (i.e., waking-up the SPS) or not (i.e., shutting-down the SPS), and also to indicate the power-save mode of operation (e.g., PS2, PS3), i.e., output current requirement, of the multi-phase converter. Typically, all SPSes of the same converter share a single SYNC signal.

Upon power-up of the VRM, signal SYNC is a logic LOW and holds the power stages in powered-UP but RESET state. A logic HIGH state on signal SYNC is designed to wake-up the SPS, i.e., to indicate that the SPS may now start operations (for e.g., following power-UP of the VRM) to generate regulated voltage Va or Vb. Correspondingly, signal PWM starts toggling after the wake-up indication by SYNC. A high-impedance (hi-Z) state (mid-rail voltage approximately mid-way between logic HIGH and logic LOW levels) on signal SYNC is designed to indicate to the SPS to shut-down, i.e., the SPS not operate to generate a regulated voltage. In the shut-down state, the SPS is designed to power-off most of its internal circuits/blocks and draw as little current as possible.

Signal CS (current-sense) is an input to phase controller 210 from an SPS, and contains information regarding the magnitude of the inductor-current of that phase. The information can be in the form of a current, voltage, digital values, etc.

Each SPS is associated with a corresponding bootstrap capacitor to drive the high-side switch in the SPS. Accordingly, the description is continued with respect to an SPS of the present disclosure.

### 4. Power Stage (SPS)

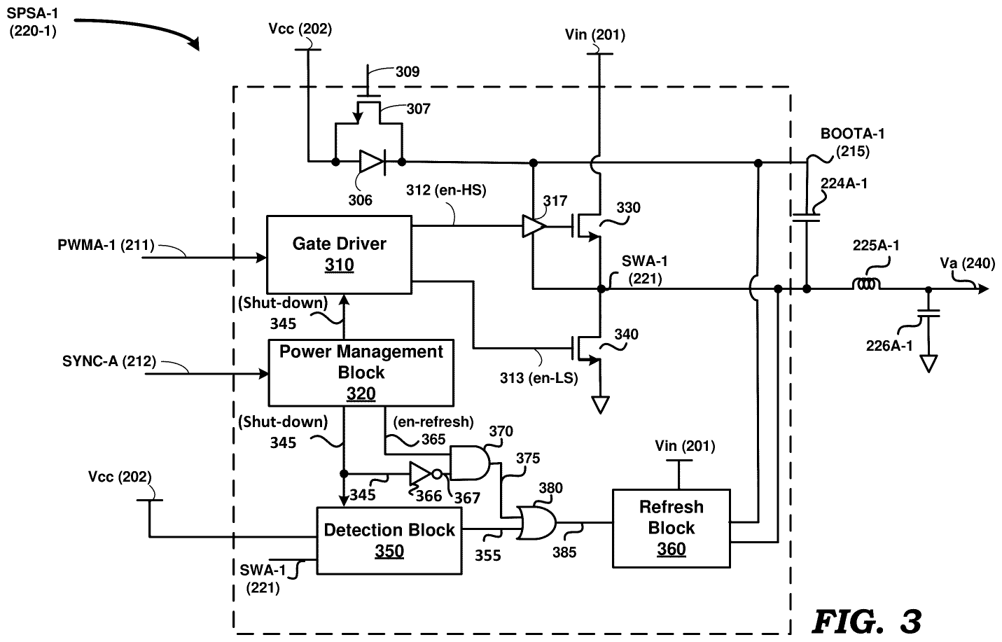

FIG. 3 is a block diagram illustrating the implementation of an SPS, in an embodiment of the present disclosure. SPSA-1 (220-1) is shown in detail in FIG. 3. The other SPSes can also be implemented to be similar to SPSA-1. However, in other embodiments, an SPS can have more or fewer blocks. SPSA-1 is shown containing gate driver 310, high-side (HS) switch 330, low-side (LS) switch 340, buffer 317, power management block 320, detection block 350, and refresh block 360. Also shown in FIG. 3 are inductor 225A-1, output capacitor 226A-1, bootstrap capacitor (Cboot) 224A-1, AND gate 370, NOT gate 366, and OR gate 380. Node 240 provides the supply voltage Va. Gate driver 310, power management block 320 and detection block 350 may be powered by Vcc (202). Each of HS switch 330 and LS switch 340 may be implemented as a power transistor (e.g., power MOSFET-Metal Oxide Semiconductor Field Effect Transistor).

Power management block 320 receives signal SYNC-A (212), and depending on the logic state of SYNC-A, generates shut-down signal 345 correspondingly. Shut-down signal 345 is connected to the desired internal blocks (not all of which are shown in FIG. 3) of power stage SPSA-1 to enable powering ON or OFF of those blocks. Thus, shut-down signal 345 is shown connected to gate driver 310 to enable gate driver 310 to be power-ON or OFF by suitable mechanisms well known in the relevant arts, and not described here in the interest of conciseness. In addition, shut-down signal 345 is also shown connected to detection block 350 to enable detection of certain conditions and consequent refreshing of Cboot, when SYNC-A is in the hi-Z state, as described below.

Upon SYNC-A transitioning to logic HIGH (3.3V in an example), as would typically happen following power-up of VRM 110, power management block 320 generates shut-down signal 345 with a logic LOW (de-asserted state) to enable all the internal blocks to be powered-ON (mechanism of such power-ON/OFF control not shown), except for detection block 350, which is instead disabled or powered-OFF. Upon SYNC-A transitioning to hi-Z (high-impedance or mid-rail), power management block 320 asserts shut-down signal 345 to logic HIGH to cause the desired internal blocks to be powered-OFF. However, to detection block 350, a logic HIGH state of shut-down signal 345 is an indication that refreshing of Cboot may be performed in the shut-down state of SPSA-1, and is described in detail below.

Shut-down generally implies that most or all internal blocks (including HS switch 330 and LS switch 340) are to be powered-down (i.e., be OFF/non-operational). In an example implementation, logic HIGH state of shut-down signal is of 3.3 V and logic LOW state of shut-down signal is of 0 V. Power management block also generates binary signal en-refresh (365) that, when asserted (e.g., to logic HIGH), enables refreshing of Cboot during normal operation of SPSA-1, i.e., when SPSA-1 is not in the shutdown state.

Gate driver 310 receives shut-down signal 345 and signal PWMA-1 (211). If shut-down signal 345 is in logic LOW state, gate driver 310 is responsive to PWMA-1 to generate appropriate voltage(s) to turn ON and turn OFF HS switch 330 and LS switch 340 in corresponding intervals indicated by PWMA-1. Turning ON a switch implies that the switch is closed and therefore provides an electrical path across the switch terminals for conduction of current. HS switch 330 and LS switch 340 connected in series operate to enable generation of regulated voltage Va at node 340 from power source Vin. Upon receiving shut-down signal 345 with logic HIGH state, gate driver 310 generates appropriate voltage(s) to turn OFF both HS switch 330 and LS switch 340. Gate driver 310 controls the ON or OFF condition of HS switch 330 and LS switch 340 via gate drive signals en-HS (312) and en-LS (313) respectively. Buffer 317 is powered by rails boot node (BOOTA-1 215) and SWA-1 (221), and operates to convert signal en-HS to voltage levels needed for driving gate terminal of HS switch 330, as will be clear from the description below.

In embodiments described herein, each of HS switch 330 and LS switch 340 is shown implemented as an N-channel Metal Oxide Semiconductor Field Effect Transistor (NMOS) for advantages such as greater current capability with lower die area due to electrons having higher mobility than holes, although other implementations for the switches having similar characteristics can benefit from the features described herein.

In the example of FIG. 3, when shut-down signal 345 is in logic LOW state and PWMA-1 is in logic HIGH state, gate driver 310 generates respective appropriate voltages on paths 312 (en-HS) and 313 (en-LS) to switch ON NMOS 330 and switch OFF NMOS 340. When shut-down signal 345 is in logic LOW state and PWMA-1 is in logic LOW state, gate driver 310 generates respective appropriate voltages on paths 312 and 313 to switch OFF NMOS 330 and switch ON NMOS 340. When shut-down signal 345 is in logic HIGH state, gate driver 310 is powered down, and gate drive signals 312 and 313 would automatically be pulled to ground (internally in gate driver 310), thereby switching OFF HS switch 330 (via buffer 317, which would be ON, and as described below) and LS switch 340.

As is well known in the relevant arts, the gate terminal of an n-type MOSFET needs to be driven to a voltage whose magnitude is higher than the voltage at the source terminal by at least a threshold value (Vt) in order to turn the switch ON. This requirement does not present a problem for LS switch 340 as the source terminal of LS switch is coupled to ground, and a voltage level corresponding to a logic HIGH on path 313 (en-LS) is sufficient to (substantially) exceed the threshold voltage of LS switch, thereby turning ON the LS switch.

In the case of HS switch 330, however, the gate terminal needs to be driven to a voltage whose magnitude is higher than Vin (201) in order to drive HS switch 330 ON with a very low ON-resistance. This is needed since as HS switch 330 starts turning ON, LS switch 340 has already been switched OFF, the voltage at node SWA-1 (221) starts increasing towards Vin, and eventually equals Vin (which may be, for example, 21 volts or so). Therefore, the gate voltage of HS switch 330 needs to be at a minimum of Vin+Vt (threshold voltage of HS switch). To turn HS switch fully ON (i.e., so that it has a very low ON-resistance and therefore operates as a switch reliably), the gate voltage may need to be sufficiently higher than (Vin+Vt). Bootstrap capacitor such as 224A-1 is employed to provide the supply voltage of buffer 317, so that buffer 317 can provide the necessary gate drive to fully turn-ON HS switch 330 as node SWA-1 rises to Vin, as is also well known in the relevant arts.

Bootstrap capacitor 224A-1 is connected between nodes BOOTA-1 (215) and SWA-1 (221).

Prior to commencement of operation of power stage 220-1 (e.g., following power-ON or RESET of VRM or the power stage), Cboot is charged to a desired voltage Vcc (equal to 3.3V) by turning on transistor switch 307 (thereby shorting diode 306) via a control signal at gate node 309 and also turning ON LS switch 340. In an embodiment, when SYNC-A is HIGH, a circuit (not shown in FIG. 3) causes transistor switch 307 and LS switch 340 to be ON for sufficient time to charge the bootstrap capacitor to 3.3 V, and then to be OFF before the commencement of normal operation in response to toggling of PWM signals. The combination of transistor switch 307, diode 306 and Vcc may be viewed as a ‘charging circuit’ for charging Cboot. During normal operation of the SPS, a ‘Cboot Refresh’ circuit (Refresh Block 360 of FIG. 3, described below) within the SPS may periodically refresh the charge on Cboot to replenish any charge lost by Cboot. Alternatively, or in addition, during normal operation of power stage 220-1, charge lost by bootstrap capacitor 224A-1 is replenished during the time period when en-LS (312) is a logic HIGH. Cboot may lose some of the accumulated charge during the time period when en-HS (313) is a logic HIGH. Further, Cboot may lose charge via leakage paths. Such loss of charge may occur even when both the HS and LS switches are OFF and the power stage is not operating to generate an output voltage.

When SPSA-1 is in shut-down state in response to signal SYNC-A (212) being in hi-Z state, it is desirable that the cross-terminal voltage across bootstrap capacitor 224A-1, i.e., the difference between the voltages at node BOOTA-1 (215) and node SWA-1 (221), be maintained at a voltage at least greater than a first threshold voltage (for example, 2V in the example of FIG. 3), to enable HS switch 330 to be reliably switched-ON upon power stage 220-1 exiting from shut-down mode to normal mode again, thereby enabling power stage 220-1 to quickly start (or contribute to) generating regulated voltage Va. Furthermore, insufficient voltage across Cboot to reliably turn-ON HS switch 330 can lead to false triggering of faults in the SPS. Or worse, such insufficient voltage can compromise the correct operation of the deadtime loop (the control mechanism in the power stage that ensures that both HS and LS switches are not ON in an overlapping duration) and damage the SPS.

It is hence generally desirable to maintain the voltage across Cboot at a sufficiently-high value and thereby keep Cboot ready for operation.

It is possible to use Vcc (3.3V) to replenish the lost charge on Cboot by charging Cboot to about 2.6V (3.3V minus the 0.7V drop due to diode 306, switch 307 being OFF). However, such an operation may be possible only under certain conditions. For example, if Cboot had completely discharged (to 0V), recharging using Vcc to 2.6V is possible only if node SWA-1 is at 0V. The first threshold voltage (minimum voltage for reliable operation of HS switch 330) noted with respect to Cboot is 2V (in the example of FIG. 3). This voltage of 2V can be guaranteed only for certain ranges of preexisting voltages across Cboot (prior to recharging) and voltages at node SWA-1. As an example, if Cboot had discharged to 1V, then even if node SWA-1 is at 0.4V, then Cboot can charge to 2.2V from Vcc. On the other hand, if Cboot had completely discharged and SWA-1 is at 1.5V, then Cboot can be charged only to a maximum of 1.1V from Vcc.

In summary, recharging Cboot to a voltage at least equal to the first threshold voltage (2V in the example) from Vcc cannot always be guaranteed if the voltage at SWA-1 is non-zero. One possible solution to such problem is to completely or substantially discharge capacitor 226A-1 by switching-ON LS switch 340 at least for a short duration. However, such discharge of capacitor 226A-1 via LS switch 340 may not be desirable since the reverse current (into LS switch 340) via inductor 225A-1 can be unacceptably high. Additionally, the body diode of the HS switch 330 can be destroyed due to the high negative inductor current.

Aspects of the present disclosure solve the problem of refreshing Cboot by employing a separate refresh circuit (refresh block 360) that draws power from Vin to recharge Cboot and does not rely on Vcc. The refreshing operation is also not affected or constrained by the voltage at node SWA-1 not being at 0V, except that the refreshing operation may be enabled only for certain ranges of voltages on SWA-1, as described below.

Continuing with reference to FIG. 3, when shut-down signal 345 is a logic HIGH, detection block 350 is designed to detect if the voltage at node SWA-1 is greater than 0.7V, and if so, to correspondingly signal refresh block 360. In response, refresh block 360 refreshes Cboot using Vin. Also shown in FIG. 3 are inverter 366, AND gate 370 and OR gate 380, which are optional components. When these optional components are not implemented, signal 355 is directly connected to refresh block 360. When shut-down signal 345 is a logic LOW, detection block 350 is powered-OFF, or alternatively, disabled from operating without being powered-OFF.

In the embodiment, the threshold voltage (second threshold) at SWA-1 is selected to be 0.7V since any voltage (approximately) 0.7V or greater at SWA-1 would mean that Cboot cannot be recharged by Vcc to at least the desired threshold voltage of 2V, as noted above, since (3.3V-0.7V-0.7V) equals only 1.9V, which is less than the desired voltage of at least 2V across Cboot. It is understood that in other environments with other values of Vcc, Vt (threshold voltage) of HS switch 330 and any other relevant parameter, the choice of the threshold voltage at SWA-1 that necessitates Cboot refreshing may be different.

Detection block 350 receives the voltage at SWA-1, Vcc (202) and shut-down signal 345 as inputs, and provides a binary signal as output on path 355, the binary signal indicating whether refreshing is to be performed or not. If SWA-1 is above 0.7V when shut-down signal 345 is at logic HIGH state, detection block 350 generates output 355 with a logic HIGH. Otherwise, detection block 350 generates output 355 with a logic LOW.

Inverter 366 generates the logical inverse 367 of the shutdown signal 345. AND gate 370 receives en-refresh signal (365) and the inverse 367 as inputs, and generates a logical AND result of the inputs on path 375. OR gate 380 generates a logical-OR output 385 of the received signals 355 and 375. Refresh block 360 refreshes Cboot when signal 385 is asserted (e.g., logic HIGH).

The description is continued with example implementations of detection block 350 and refresh block 360 of the present disclosure.

### 5. Detection Block and Refresh Block

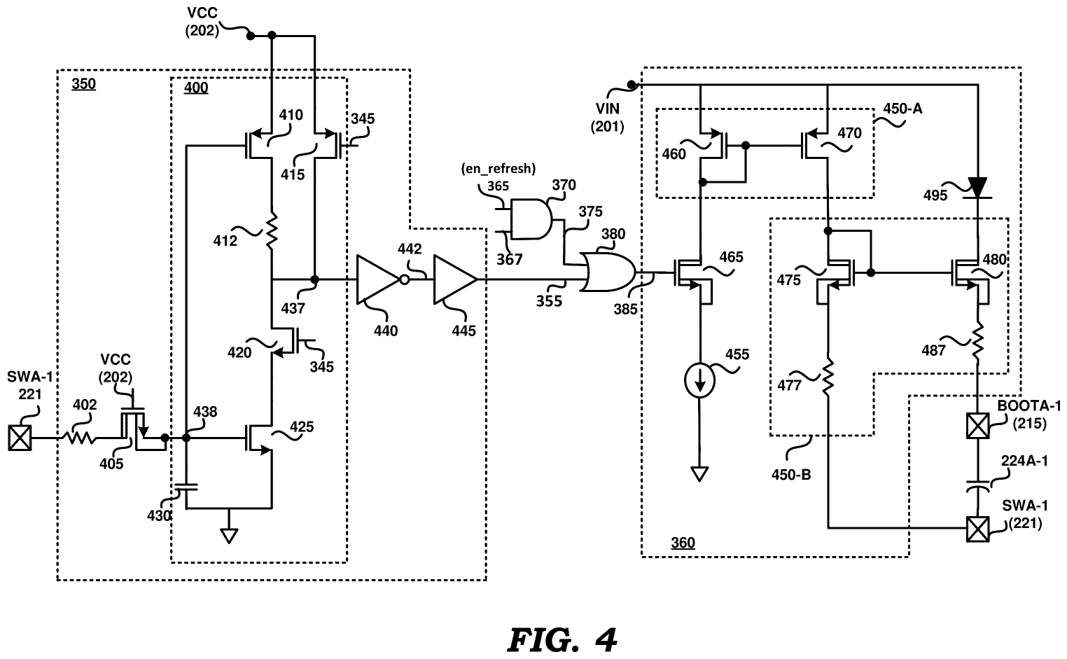

FIG. 4 is a diagram illustrating an example implementation of detection block 350 and refresh block 360 in an embodiment of the present disclosure. Optional components AND gate 370 and OR gate 380 are also shown for clarity.

### Detection Block

Detection block 350 is shown containing circuit 400, resistor 402, NMOS 405, inverter 440, and buffer 445. In alternative implementations, detection block 350 may be implemented with more or fewer components and circuitry, as will be apparent to a skilled practitioner by reading the disclosure herein.

Node SWA-1 is connected to node 438 of circuit 400 via the series combination of resistor 402 and NMOS 405. The gate terminal and bulk (substrate) terminal of NMOS 405 are respectively connected to Vcc and node 438. The output of circuit 400 is provided at node 437, which is connected to inverter 440. Inverter 440 generates the logical inverse 442 of signal 437, and buffer 445 drives signal 442 on to path 355.

Circuit 400 is an NMOS Vt-based inverter. The trip-point of circuit 400 equals the threshold voltage (Vt) of an NMOS (425 in the example). The trip-point refers to the voltage at which the inverter's output flips between the two logic states HIGH and LOW. Circuit 400 is shown containing transistors/switches 410, 415, 420 and 425, resistor 412 and capacitor 430. Nodes 437 and 438 are also shown, and may respectively be referred to as a ‘first intermediate node’ and a ‘second intermediate node’. Transistors 410 and 415 are PMOS transistors, while transistors 420 and 425 are NMOS transistors. Transistor 405 is shown implemented as a high-voltage (e.g., 30V) tolerant transistor, while transistors 410, 415, 420 and 425 may be low-voltage (e.g., 0V-3.3V or 0V-5V) tolerant components. As is well known in the relevant arts, a high-voltage transistor refers to a transistor that is capable of withstanding large (e.g., 30V) drain-to-source voltages without break-down, i.e., has a high breakdown voltage specification. The 30V tolerance noted above is an example only, and the specific voltage depends on the maximum voltage on node SWA-1. Transistor 405 needs to support higher breakdown voltages since Vsw can go as high as Vin (201), which in the examples herein is around 21 volts.

Transistor 410 and resistor 412, shown connected in series between Vcc and first intermediate node 437, form a ‘first circuit portion’. The source, drain and gate terminals of transistor 410 are connected respectively to Vcc, one end of resistor 412 and ‘second intermediate node’ 438. Transistor 415, shown connected between Vcc and ‘first intermediate node’ 437, forms a ‘second circuit portion’. The source, drain and gate terminals of transistor 415 are respectively shown connected to Vcc, the ‘first intermediate node’ 437 and shut-down signal 345. The ‘first circuit portion’ and the ‘second circuit portion’ are connected in parallel, as may be readily observed from FIG. 4.

Transistors 420 and 425, shown connected in series between first intermediate node 437 and ground, form a ‘third circuit portion’. The source, drain and gate terminals of transistor 420 are respectively shown connected to the drain terminal of transistor 425, the ‘first intermediate node’ 437 and shut-down signal 345. The source and gate terminals of transistor 425 are respectively shown connected to ground and second intermediate node 438. The ‘third circuit portion’ is shown in series with the parallel combination of the ‘first circuit portion’ and the ‘second circuit portion’.

Resistor 402 and transistor 405 form a fourth circuit portion. The source, drain and gate terminals of transistor 405 are respectively shown connected to the ‘second intermediate node’ 438, node SWA-1 (221) (via resistor 402) and Vcc. Capacitor 430 is connected between the ‘second intermediate node’ 438 and ground.

The logic gates shown in FIG. 4 operate on low voltages, and in an embodiment, operate from Vcc (3.3V)

The description is continued below with respect to the operation of detection block 350 based on the logic state of shut-down signal 345. For both logic states of shut-down signal 345, NMOS 405 would be ON, and the consequent voltage across capacitor 430 depends on the voltage Vsw. The threshold voltages of all NMOS transistors and all PMOS transistors of detection block 350 are respectively +0.7V and −0.7V.

### Operation of Detection Block when Shut-Down Signal 345 is a Logic HIGH

When shut-down signal 345 is a logic HIGH state (for example, 3.3 V), PMOS 415 is OFF, and therefore the ‘second circuit portion’ acts as an open circuit.

If Vsw (voltage at node 221) is greater than 0.7 V (second threshold voltage), capacitor 430 charges to such voltage of Vsw (up to a maximum of (3.3V−Vt) of NMOS 405). Threshold voltage of NMOS 425 is 0.7V, and NMOS 425 switches ON if Vsw is equal to or greater than 0.7V. As a consequence, transistor 420 also switches ON (its gate is already at logic HIGH)). PMOS 410 also switches ON state since the voltage node 438 and therefore at gate terminal of PMOS 410 is (3.3V-0.7) V or less.

As a result, voltage at ‘first intermediate node’ 437 will be approximately zero (logic LOW), and a logic HIGH is generated on path 355, thereby signalling refresh block 360 to refresh Cboot, as described further below.

If Vsw is less than 0.7 V, transistor 425 is OFF, transistor 420 is OFF and transistor 410 is ON. As a result, the voltage at node 437 is approximately Vcc, and signals a logic HIGH. Therefore, a logic LOW is generated on path 355, thereby signalling refresh block 360 not to refresh Cboot, as described further below.

### Operation of Detection Block when Shut-Down Signal 345 is a Logic LOW

In an embodiment of the present disclosure, when shut-down signal is a logic LOW, detection block 350 is powered-OFF. Thus, the connection of detection block 350 to Vcc may be broken by suitable mechanisms well known in the relevant arts, and not described here in the interest of conciseness. Buffer 445 is designed to have an internal weak pull-down to ground, such that when detection block is powered-OFF (inverter 440 and buffer 445 would also be powered OFF by disconnection from Vcc for example—although the connections are not shown), signal 355 is a logic LOW to signal refresh block 360 not to refresh Cboot.

In an alternative embodiment of the present disclosure, detection block 350 is not power-OFF. With shut-down signal 345 in logic-LOW state, transistor 415 is ON and transistor 420 is OFF, and the voltage at the ‘first intermediate node’ 437 will be approximately Vcc (equivalent to a logic HIGH) irrespective of the value of Vsw. As a result, a logic LOW is generated on path 355, thereby signalling refresh block 360 not to refresh Cboot.

Thus, signal on path 355 (i.e., output of detection circuit 350) will be in logic HIGH state only when shut-down signal 345 is in logic HIGH state and Vsw is greater than 0.7V.

The description is continued below with an example implementation and operation of refresh block 360.

### Refresh Block

Refresh block 360 is shown containing circuits 450-A and 450-B, NMOS 465, current sink 455, and diode 495. Also shown for clarity are Cboot 224A-1 and nodes BOOTA-1 and SWA-1. Refresh block 360 directly uses Vin (201) as the power source for refreshing Cboot.

Circuit 450-A is shown containing PMOS transistors 460 and 470, and circuit 450-B is shown containing NMOS transistors 475 and 480, and resistors 477 and 487. Circuits 450-A and 450-B represent current-mirror circuits. The transistors of each current-mirror are matched and have the same dimensions, and therefore the ratio of the currents through the transistors of each mirror is 1:1. Transistors 465, 475 and 480 are shown as high-voltage (e.g., 30 V) tolerant transistors, while transistors 460 and 470 are only low-voltage (e.g., 0V-3.3V or 0V-5V) tolerant components.

Current sink 455, NMOS 465 and PMOS 460 are shown connected in series between Vin (201) and ground. The source and drain terminals of PMOS 460 are respectively connected to Vin (201) and the drain terminal of NMOS 465. The gate terminal of PMOS 460 is connected to the gate terminal of PMOS 470 as well as to the drain terminal of PMOS 460. The source and gate terminals of NMOS 465 are respectively connected to one terminal of current sink 455 and output 385 of OR gate 380. The second terminal of current sink 455 is connected to ground.

PMOS 470, NMOS 475 and resistor 477 are shown connected in series between Vin (201) and node SWA-1 (221). The source and drain terminals of PMOS 470 are respectively connected to Vin (201) and the drain terminal of NMOS 475. The source and gate terminals of NMOS 475 are respectively connected to one end of resistor 477 and the drain terminal of NMOS 475. The gate terminal of NMOS 475 is also connected to the gate terminal of NMOS 480.

Diode 495, NMOS 480 and resistor 487 are connected in series between Vin (201) and node BOOTA-1 (215). The anode of diode 495 is connected to Vin (201) and the cathode of diode 495 is connected to the drain terminal of NMOS 480. The source terminal of NMOS 480 is connected to node BOOTA-1 via resistor 487.

The bulk terminals of NMOS transistors 465, 475 and 480 are connected to the respective source terminals of the corresponding NMOS transistor.

By design, the sink current (I1) of current-sink 455 is set to equal 3.3V/R477, wherein R477 is the resistance of resistor 477. Therefore, the drop across resistor 477 is also 3.3V (current through resistor 477 being equal to I1, as described below). Further, the resistance R477 is selected such that current I1 causes a voltage drop across PMOS 470 such that the drain terminal of PMOS 470, and therefore the gate terminals of NMOS 475 and 480 are biased at a voltage equal to (Vsw+3.3V+Vt) volts, wherein Vt is the threshold voltage of NMOS 480.

The operation of refresh block 360 is described next.

When the binary signal on path 385 is at logic HIGH, NMOS 465 is ON, and a current of magnitude I1 (equal to the magnitude of sink current of current-sink 455) flows through the series path formed by PMOS460, NMOS 465 and sink 455.

Since transistors 460 and 470 form a current-mirror pair with current ratio of 1:1, the magnitude of current flowing through the series path formed by PMOS 470, NMOS 475 and resistor 477 is also I1. Since transistors 475 and 480 also form a current-mirror pair with current ratio of 1:1, the magnitude of current flowing through the series path formed by diode 495, NMOS 480 and resistor 487 is also I1, which charges bootstrap capacitor (Cboot) 224A-1. Resistor 487 is a current-limiting resistor.

The refreshing/charging of Cboot continues till the voltage across Cboot equals 3.3V, at which point, refreshing/charging stops automatically (until/unless voltage across Cboot drops below 3.3V again). This is because the gate of NMOS 480 is biased at voltage (Vsw+3.3V+Vt) volts, as noted above, and any increase above 3.3V of the voltage across Cboot would cause the gate-source voltage Vgs of NMOS 480 to fall below its threshold voltage Vt, and therefore switch-OFF NMOS 480. Therefore, when the voltage across Cboot reaches 3.3V, charging stops until Cboot loses some charge and causes Vgs of NMOS 480 to become greater than Vt.

Diode 495 is used to protect Vin (201) from reverse current from Cboot which would cause Cboot to lose charge, since Vsw can go as high as Vin (201) and voltage at BOOTA-1 can go as high as Vin+3.3 V during normal operation.

When the signal on path 385 is in logic LOW state, transistor 465 is OFF thereby causing the other transistors also to be OFF and no refreshing takes place.

Referring to FIG. 3, it is noted that refresh block 360 may also be used to refresh Cboot during normal operation. Such refreshing occurs when signal en-refresh (365) generated by power management block 320 is a logic HIGH. During normal operation, shutdown signal 345 would be a logic LOW, and signal 367 would be a logic HIGH, causing signal 385 to be a logic HIGH and refresh block 360 would operate to refresh Cboot whenever en-refresh (365) is a logic HIGH (for e.g., at pre-determined intervals).

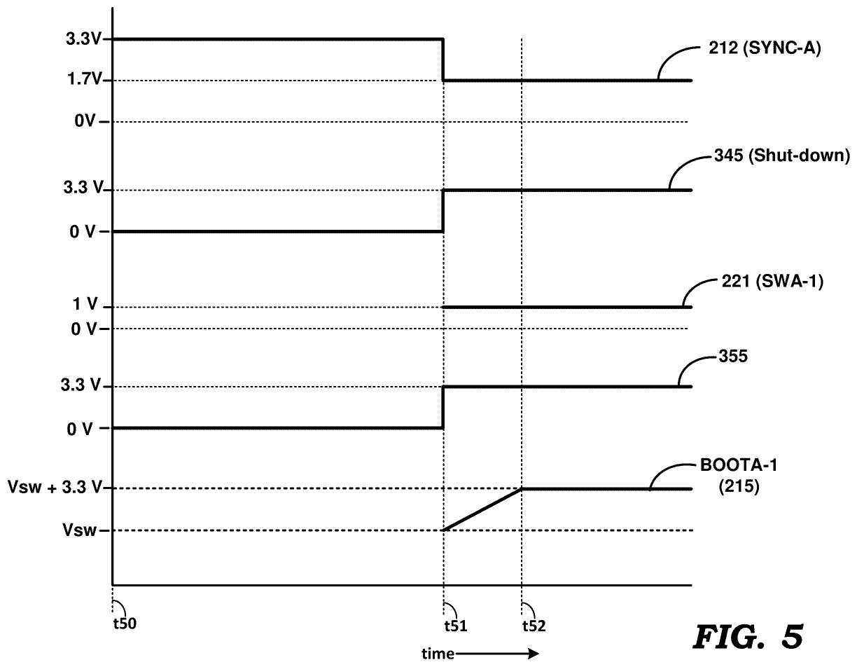

The operation of power management block 320, detection block 350 and refresh block 360 is illustrated next with respect to the example waveforms of FIG. 5.

FIG. 5 shows example waveforms for signals SYNC-A, shut-down, voltage at SWA-1 (Vsw), signal 355 and voltage at node BOOTA-1.

In time interval t50-t51, SYNC-A is shown to be a logic HIGH. Accordingly, shut-down signal 345 and signal 355 are both a logic LOW. The waveform for the voltage Vsw (at node SWA-1) is not shown in the interval t50-t51 for simplicity, but would switch between 0V and Vin due to the operation of the HS and LS switches. Similarly, the waveform for the voltage at node BOOTA-1 is also not shown in the interval t50-t51, but would switch between 3.3V and Vin+3.3V, again due to the operation of the HS and LS switches.

At t51, SYNC-A is shown switching to Hi-Z state (mid-rail voltage of 1.7V). In response, shut-down signal 345 and signal 355 both switch to logic HIGH. Vsw (voltage at node SWA-1) is shown to be 1V from t51. In response to signal 355 switching to logic HIGH, refresh block 360 refreshes Cboot in the manner described above. Accordingly, and assuming Cboot had been completely discharged, the voltage across Cboot is shown increasing linearly from t51 until it reaches 3.3V. Correspondingly, the voltage at node BOOTA-1 is shown linearly changing from Vsw at 151 to Vsw+3.3V at t52, and thereafter remaining constant at Vsw+3.3V due to any leakage of charge from Cboot being quickly replenished since both detection block 350 and refresh block 360 continue to be operative for the entire duration that SPSA-1 is in the shut-down state.

However, in an alternative embodiment of the present disclosure, refresh block 360 is implemented to detect the voltage across Cboot. When Cboot is fully charged to 3.3V, refresh block 360 may be implemented to indicate to power management block 320 that Cboot is fully charged. Upon receipt of such indication, power management block 320 may switch-OFF power to detection block 350. Alternatively, refresh block 360 may directly indicate to detection block 350 when Cboot is fully charged, and in response, detection block 350 powers-OFF using suitable mechanisms well known in the art.

In an embodiment of the present disclosure, inverter 400 draws approximately 6 micro-Amperes (uA) when its output (node 437) is at logic HIGH. In the typical condition when Va (240) is 0V, SWA-1 is also at 0V, and no additional current is drawn by refresh block 360. When SWA-1 is at a voltage greater than Vt of NMOS 425, refresh block 360 is enabled and draws approximately 15 uA current from Vin (201) and Vcc (202) to keep Cboot refreshed.

### 6. Conclusion

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

While in the illustrations of FIGS. 1 through 4, although terminals/nodes are shown with direct connections to (i.e., “connected to”) various other terminals, it should be appreciated that additional components (as suited for the specific environment) may also be present in the path, and accordingly the connections may be viewed as being “electrically coupled” to the same connected terminals.

It should be appreciated that the specific type of transistors (such as NMOS, PMOS, etc.) noted above are merely by way of illustration. However, alternative embodiments using different configurations and transistors will be apparent to one skilled in the relevant arts by reading the disclosure provided herein. For example, the NMOS transistors may be replaced with PMOS (P-channel MOS) transistors, while also interchanging the connections to power and ground terminals.

Accordingly, in the instant application, the power and ground terminals are referred to as constant reference potentials, the source (emitter) and drain (collector) terminals of transistors (though which a current path is provided when turned on and an open path is provided when turned off) are termed as current terminals, and the gate (base) terminal is termed as a control terminal.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A power stage of a voltage regulator comprising:
a high-side switch and a low-side switch coupled in series between an external power source at an input node and a constant reference potential, and being respectively operated by a first drive signal and a second drive signal, said first drive signal and said second drive signal to be respectively ON to drive respective currents through an inductor in a high-side phase and a low-side phase to provide a regulated output voltage;
a gate driver to generate said first drive signal and said second drive signal based on a control signal received from a phase controller, wherein said control signal is received with a first logic level in a first interval and with a second logic level in a second interval;
a power management block to receive a power-control signal, wherein if said power-control signal is in a first state, said power management block causes both of said high-side switch and said low-side switch to switch to OFF state;
a bootstrap capacitor, wherein a first terminal of said bootstrap capacitor is coupled to a control terminal of said high-side switch and a second terminal of said bootstrap capacitor is coupled to a first current terminal of said high-side switch, said bootstrap capacitor to enable said high-side switch to be switched ON,
wherein the cross-terminal voltage between said first terminal and said second terminal of said bootstrap capacitor is required to be equal to or greater than a first threshold voltage for reliable operation of said high-side switch; and
a refresh block to refresh said bootstrap capacitor to maintain said cross-terminal voltage equal to or greater than said first threshold voltage while said high-side switch and said low-side switch continue to be in said OFF state when said power-control signal is in said first state.

2. The power stage of claim 1, wherein said power-control signal in said first state indicates that said power stage is not to generate said regulated output voltage,
wherein maintaining said cross-terminal voltage above said first threshold voltage when said power-control signal is in said first state enables said high-side switch to quickly start generating said regulated output voltage when said power-control signal changes to a second state indicating that said power stage is to generate said regulated output voltage.

3. The power stage of claim 1, wherein said power management block receives said power-control signal and determines whether said power-control signal is in said first state, and generates a shut-down signal if said power-control signal is in said first state, wherein said shut-down signal causes both of said high-side switch and said low-side switch to switch to OFF state.

4. The power stage of claim 3, further comprising:
a detection block to detect whether a voltage at said second terminal of said bootstrap capacitor is above a second threshold voltage, said detection block coupled to receive said shut-down signal and to cause said refresh block to refresh said bootstrap capacitor to maintain said cross-terminal voltage above said first threshold voltage only if said voltage at said second terminal of said bootstrap capacitor is above said second threshold voltage.

5. The power stage of claim 4, further comprising a charging circuit to charge said bootstrap capacitor from a low-voltage power source,
wherein said second threshold voltage represents the maximum voltage that when present at said second terminal of said bootstrap capacitor when said power-control signal is in said first state enables said charging circuit to charge said bootstrap capacitor to maintain said cross-terminal voltage at least equal to said first threshold voltage,
wherein said refresh block refreshes said bootstrap capacitor using said external power source, wherein an output voltage of said external power source is greater than an output voltage of said low-voltage power source.

6. The power stage of claim 5, wherein said detection block comprises:
an inverter circuit designed to have a trip-point equal to the threshold voltage of an MOSFET (Metal Oxide Semiconductor Field Effect Transistor), said inverter circuit coupled to receive said voltage at said second terminal of said bootstrap capacitor, said inverter circuit to generate a logic LOW signal as an output signal of said inverter circuit when said voltage at said second terminal of said bootstrap capacitor is above said second threshold voltage, and a logic HIGH signal as said output signal otherwise; and
a logic inverter to generate the logical inverse of said output signal of said inverter circuit.

7. The power stage of claim 6, wherein said refresh block comprises:
a first PMOS (P-channel MOSFET), a first NMOS (N-channel MOSFET) and a current sink coupled in series between said input node and said constant reference potential;
a second PMOS, a second NMOS and a first resistor coupled in series between said input node and said second terminal of said bootstrap capacitor; and
a diode, a third NMOS and a second resistor coupled in series between said input node and said first terminal of said bootstrap capacitor,
wherein said first PMOS and said second PMOS are coupled in a current-mirror configuration to form a first current mirror,
wherein said second NMOS and said third NMOS are coupled in a current-mirror configuration to form a second current mirror, and
wherein a control terminal of said first NMOS is coupled to receive said logical inverse.

8. The power stage of claim 7, wherein a current of said current-sink is set to be equal to the ratio of said output voltage of said low-voltage power source and the resistance of said first resistor,
wherein said resistance equals a value that causes a current flowing through said second PMOS to cause a voltage-drop across said second PMOS that in turn causes the control terminals of each of said second NMOS and said third NMOS to be biased at a voltage equal to the sum of the voltage at said second terminal of said capacitor, said output voltage of said low-voltage power source and the threshold voltage of said third NMOS, thereby limiting charging of said bootstrap capacitor to a voltage equal to said output voltage of said low-voltage power source.

9. The power stage of claim 6, wherein said inverter circuit comprises:
a first circuit portion comprising a third PMOS and a third resistor connected in series between said low-voltage power source and a first intermediate node, wherein source, drain and gate terminals of said third PMOS are connected respectively to said low-voltage power source, one end of said third resistor and a second intermediate node;
a second circuit portion comprising a fourth PMOS connected between said low-voltage power source and said first intermediate node, wherein source, drain and gate terminals of said fourth PMOS are connected respectively to said low-voltage power source, said first intermediate node and said shut-down signal;
a third circuit portion comprising a fourth NMOS and a fifth NMOS connected in series between said first intermediate node and said constant reference potential, wherein source, drain and gate terminals of said fourth NMOS are connected respectively to drain terminal of said fifth NMOS, said first intermediate node and said shut-down signal, and wherein source and gate terminals of said fifth NMOS are connected respectively to said constant reference potential and said second intermediate node; and
a first capacitor connected between said second intermediate node and said constant reference potential,
wherein said first circuit portion and said second circuit portion are in parallel, and said third circuit portion is in series with said parallel combination of said first circuit portion and said second circuit portion.

10. The power stage of claim 9, wherein said inverter circuit is coupled to receive said voltage at said second terminal of said bootstrap capacitor via a fourth circuit portion,
wherein said fourth circuit portion comprises a fourth resistor and a sixth NMOS connected in series, wherein source, drain and gate terminals of said sixth NMOS are connected respectively to said second intermediate node, said second terminal of said bootstrap capacitor via said fourth resistor and said low-voltage power source.

11. A voltage regulator module (VRM) comprising:
a plurality of power stages providing a regulated output voltage on a power rail; and
a phase controller to control the operation of each of said plurality of power stages to provide said regulated output voltage, wherein a first power stage of said plurality of power stages comprises:
a high-side switch and a low-side switch coupled in series between an external power source at an input node and a constant reference potential, and being respectively operated by a first drive signal and a second drive signal, said first drive signal and said second drive signal to be respectively ON to drive respective currents through an inductor in a high-side phase and a low-side phase to provide said regulated output voltage;
a gate driver to generate said first drive signal and said second drive signal based on a control signal received from said phase controller, wherein said control signal is received with a first logic level in a first interval and with a second logic level in a second interval;
a power management block to receive a power-control signal, wherein if said power-control signal is in a first state, said power management block causes both of said high-side switch and said low-side switch to switch to OFF state;
a bootstrap capacitor, wherein a first terminal of said bootstrap capacitor is coupled to a control terminal of said high-side switch and a second terminal of said bootstrap capacitor is coupled to a first current terminal of said high-side switch, said bootstrap capacitor to enable said high-side switch to be switched ON;
wherein the cross-terminal voltage between said first terminal and said second terminal of said bootstrap capacitor is required to be equal to or greater than a first threshold voltage for reliable operation of said high-side switch; and
a refresh block to refresh said bootstrap capacitor to maintain said cross-terminal voltage equal to or greater than said first threshold voltage while said high-side switch and said low-side switch continue to be in said OFF state when said power-control signal is in said first state.

12. The VRM of claim 11, wherein said power-control signal in said first state indicates that said power stage is not to generate said regulated output voltage,
wherein maintaining said cross-terminal voltage above said first threshold voltage when said power-control signal is in said first state enables said high-side switch to quickly start generating said regulated output voltage when said power-control signal changes to a second state indicating that said power stage is to generate said regulated output voltage.

13. The VRM of claim 11, wherein said power management block receives said power-control signal and determines whether said power-control signal is in said first state, and generates a shut-down signal if said power-control signal is in said first state, wherein said shut-down signal causes both of said high-side switch and said low-side switch to switch to OFF state.

14. The VRM of claim 13, wherein said first power stage further comprising:
a detection block to detect whether a voltage at said second terminal of said bootstrap capacitor is above a second threshold voltage, said detection block coupled to receive said shut-down signal and to cause said refresh block to refresh said bootstrap capacitor to maintain said cross-terminal voltage above said first threshold voltage only if said voltage at said second terminal of said bootstrap capacitor is above said second threshold voltage.

15. The VRM of claim 13, wherein said first power stage further comprising a charging circuit to charge said bootstrap capacitor from a low-voltage power source,
wherein said second threshold voltage represents the maximum voltage that when present at said second terminal of said bootstrap capacitor when said power-control signal is in said first state enables said charging circuit to charge said bootstrap capacitor to maintain said cross-terminal voltage at least equal to said first threshold voltage,
wherein said refresh block refreshes said bootstrap capacitor using said external power source, wherein an output voltage of said external power source is greater than an output voltage of said low-voltage power source.

16. The VRM of claim 15, wherein said detection block comprises:
an inverter circuit designed to have a trip-point equal to the threshold voltage of an MOSFET (Metal Oxide Semiconductor Field Effect Transistor), said inverter circuit coupled to receive said voltage at said second terminal of said bootstrap capacitor, said inverter circuit to generate a logic LOW signal as an output signal of said inverter circuit when said voltage at said second terminal of said bootstrap capacitor is above said second threshold voltage, and a logic HIGH signal as said output signal otherwise; and
a logic inverter to generate the logical inverse of said output signal of said inverter circuit.

17. The VRM of claim 16, wherein said refresh block comprises:
a first PMOS (P-channel MOSFET), a first NMOS (N-channel MOSFET) and a current sink coupled in series between said input node and said constant reference potential;
a second PMOS, a second NMOS and a first resistor coupled in series between said input node and said second terminal of said bootstrap capacitor; and
a diode, a third NMOS and a second resistor coupled in series between said input node and said first terminal of said bootstrap capacitor,
wherein said first PMOS and said second PMOS are coupled in a current-mirror configuration to form a first current mirror,
wherein said second NMOS and said third NMOS are coupled in a current-mirror configuration to form a second current mirror, and
wherein a control terminal of said first NMOS is coupled to receive said logical inverse.

18. The VRM of claim 17, wherein a current of said current-sink is set to be equal to the ratio of said output voltage of said low-voltage power source and the resistance of said first resistor,
wherein said resistance equals a value that causes a current flowing through said second PMOS to cause a voltage-drop across said second PMOS that in turn causes the control terminals of each of said second NMOS and said third NMOS to be biased at a voltage equal to the sum of the voltage at said second terminal of said capacitor, said output voltage of said low-voltage power source and the threshold voltage of said third NMOS, thereby limiting charging of said bootstrap capacitor to a voltage equal to said output voltage of said low-voltage power source.

19. The VRM of claim 16, wherein said inverter circuit comprises:
a first circuit portion comprising a third PMOS and a third resistor connected in series between said low-voltage power source and a first intermediate node, wherein source, drain and gate terminals of said third PMOS are connected respectively to said low-voltage power source, one end of said third resistor and a second intermediate node;
a second circuit portion comprising a fourth PMOS connected between said low-voltage power source and said first intermediate node, wherein source, drain and gate terminals of said fourth PMOS are connected respectively to said low-voltage power source, said first intermediate node and said shut-down signal;
a third circuit portion comprising a fourth NMOS and a fifth NMOS connected in series between said first intermediate node and said constant reference potential, wherein source, drain and gate terminals of said fourth NMOS are connected respectively to drain terminal of said fifth NMOS, said first intermediate node and said shut-down signal, and wherein source and gate terminals of said fifth NMOS are connected respectively to said constant reference potential and said second intermediate node; and
a first capacitor connected between said second intermediate node and said constant reference potential,
wherein said first circuit portion and said second circuit portion are in parallel, and said third circuit portion is in series with said parallel combination of said first circuit portion and said second circuit portion.

20. The VRM of claim 19, wherein said inverter circuit is coupled to receive said voltage at said second terminal of said bootstrap capacitor via a fourth circuit portion,
wherein said fourth circuit portion comprises a fourth resistor and a sixth NMOS connected in series, wherein source, drain and gate terminals of said sixth NMOS are connected respectively to said second intermediate node, said second terminal of said bootstrap capacitor via said fourth resistor and said low-voltage power source.
